(19) United States
(12) Patent Application Publication
(10) Pub. No.: US 2021/0080280 A1
(43) Pub. Date: Mar. 18, 2021

(54) POSITIONING SYSTEM AND POSITIONING METHOD

(71) Applicant: NEC Corporation, Minato-ku, Tokyo (JP)

(72) Inventor: Makoto FUJINAMI, Tokyo (JP)

(73) Assignee: NEC Corporation, Minato-ku, Tokyo (JP)

(21) Appl. No.: 17/054,660

(22) PCT Filed: May 13, 2019
(86) PCT No.: PCT/JP2019/018918

§ 371 Date: Nov. 11, 2020

(30) Foreign Application Priority Data
May 15, 2018 (JP) 2018-093665

(51) Int. Cl. G01C 21/36; G01S 19/48

(52) U.S. Cl. CPC G01C 21/367; G01S 19/48

(57) ABSTRACT

A positioning system includes a terminal device that measures a position of the terminal device by using a first positioning method using first positioning signals transmitted from satellites included in a global positioning system and a second positioning method different from the first positioning method and a server device that transmits a positioning method setting instruction including a positioning method based on the position of the terminal device to the terminal device, in order to achieve continuous positioning without depending on a reception state of radio waves transmitted from the satellites included in the global positioning system.

### TECHNICAL FIELD

The present invention relates to a positioning system, a terminal device, and a positioning method. In particular, the present invention relates to a positioning system, a terminal device, and a positioning method using a global positioning system.

### BACKGROUND ART

A terminal device that mounts a Global Positioning System (GPS) receiver that receives radio waves transmitted from a GPS can position a position of the terminal device by receiving the radio waves from GPS satellite. There is a case where such a terminal device cannot perform positioning in an indoor where the radio waves from the GPS satellite do not reach, an area including a large number of tall buildings where reflected waves are large, or the like. In such a case, the terminal device switches a positioning method to a positioning method other than the GPS method and suppresses deterioration in positioning accuracy.

PTL 1 discloses an information processing apparatus that measures a current position by different methods. The apparatus in PTL 1 includes a plurality of positioning means that measures the current position by the different methods and accuracy acquisition means that acquires accuracy of positioning by the positioning means that can perform positioning from among the plurality of positioning means.

PTL 2 discloses a positioning method determination system that includes a mobile device that can position the current position and a server that communicates with the mobile device. The mobile device in PTL 2 includes a plurality of positioning means that can acquire positioning information regarding the current position, and in a case where acquisition of the positioning information by the single positioning means among the plurality of positioning means fails, the mobile device transmits positioning information that has been acquired immediately before the failure of the acquisition of the positioning information to the server. The server receives the positioning information from the mobile device, stores positioning means that can be used in each communication area as communication area information, and transmits means instruction information indicating positioning means determined based on the received positioning information and the stored communication area information to the mobile device. The mobile device measures the current position by using the positioning means indicated by the means instruction information received from the server.

PTL 3 discloses a communication terminal that has a navigation function for guiding a route to a destination based on map data divided into a plurality of regions. The communication terminal in PTL 3 includes a storage unit that stores map data of at least one region, a plurality of positioning units that measures a position of the communication terminal by different positioning methods, and a control unit that controls an operation of the communication terminal. The control unit acquires setting of a positioning method associated with each region based on a priority associated with each region in the map data. The positioning unit measures a position of the communication terminal according to setting of the positioning method associated with each region.

### CITATION LIST

### Patent Literature

### [PTL 1] JP 2005-326225 A

### [PTL 2] JP 2010-145356 A

### [PTL 3] JP 2017-106864 A

### SUMMARY OF INVENTION

### Technical Problem

According to the method in PTL 1, by performing positioning by the plurality of positioning methods and selecting a positioning method with which a good result can be obtained, it is possible to acquire information for enabling an application to preferably display a current position. However, with the method in PTL 1, in a case where deterioration in GPS positioning accuracy is not accurately detected, the deterioration in the positioning accuracy is detected only when positioning cannot be performed. Therefore, the method in PTL 1 has had a problem in that positioning cannot be temporarily performed in a time period when the positioning method is switched to another positioning method.

According to the method in PTL 2, in a case where acquisition of the positioning information by the mobile device fails, it is possible to position the current position by using positioning means that can be used in each communication area. However, the method in PTL 2 has had a problem in that positioning cannot be temporarily performed in a time period when the positioning means is switched to the other positioning means after the failure of the acquisition of the positioning information by the mobile device.

In the method in PTL 3, the position of the communication terminal is measured according to the setting of the positioning method associated with each region, based on the priority associated with each region in the map data. Therefore, according to the method in PTL 3, it is possible to continue to download the map data from the server even in a region where a communication environment is not excellent. However, the method in PTL 3 has had a problem in that a delay occurs in switching of the positioning method depending on a timing when the setting of the positioning method is received by the communication terminal and positioning cannot be temporarily performed.

An object of the present invention is to solve the above problems and to provide a positioning system that can achieve continuous positioning without depending on a reception state of radio waves transmitted from satellites included in a global positioning system.

### Solution to Problem

A positioning system according to one aspect of the present invention includes a server device that transmits a positioning method setting instruction for specifying a positioning method based on a position of a terminal device to the terminal device and a terminal device that measures a position of the terminal device by using at least either one of a first positioning method using first positioning signals transmitted from a plurality of satellites included in a global positioning system or at least one second positioning method different from the first positioning method according to the positioning method setting instruction.

A terminal device according to one aspect of the present invention includes reception means for receiving first positioning signals transmitted from a plurality of satellites included in a global positioning system, first positioning means for measuring a position of the terminal device by a first positioning method using the first positioning signal, second positioning means for measuring the position of the terminal device by at least one second positioning method different from the first positioning method, inquiry means for transmitting a primary positioning result including the position of the terminal device to a server device and receiving a positioning method setting instruction according to the primary positioning result from the server device, positioning method switching means for selecting a positioning result measured by a positioning method based on the positioning method setting instruction received by the inquiry means, and positioning result output means for outputting the positioning result selected by the positioning method switching means.

A positioning method according to one aspect of the present invention includes transmitting a positioning method setting instruction for specifying a positioning method based on a position of a terminal device to the terminal device and measuring the position of the terminal device by using at least either one of a first positioning method using first positioning signals transmitted from a plurality of satellites included in a global positioning system or at least one second positioning method different from the first positioning method according to the positioning method setting instruction.

### Advantageous Effects of Invention

According to the present invention, a positioning system can be provided that can achieve continuous positioning without depending on a reception state of radio waves transmitted from satellites included in a global positioning system.

### BRIEF DESCRIPTION OF DRAWINGS

FIG. 1 is a conceptual diagram illustrating a schematic configuration of a positioning system according to a first example embodiment of the present invention.

FIG. 2 is a block diagram illustrating an example of a configuration of a terminal device of the positioning system according to the first example embodiment of the present invention.

FIG. 3 is a block diagram illustrating an example of a configuration of a server device of the positioning system according to the first example embodiment of the present invention.

FIG. 4 is a list illustrating an example of a positioning method setting instruction transmitted from the server device of the positioning system according to the first example embodiment of the present invention.

FIG. 5 is a conceptual diagram illustrating a positioning region where a positioning method is set to a positioning method other than a GPS method according to coordinates included in the positioning method setting instruction transmitted from the server device of the positioning system according to the first example embodiment of the present invention.

FIG. 6 is a list illustrating another example of the positioning method setting instruction transmitted from the server device of the positioning system according to the first example embodiment of the present invention.

FIG. 7 is a conceptual diagram illustrating a positioning region where the positioning method is set to the GPS method according to coordinates included in the positioning method setting instruction transmitted from the server device of the positioning system according to the first example embodiment of the present invention.

FIG. 8 is a flowchart for explaining an example of an operation of the positioning system according to the first example embodiment of the present invention.

FIG. 9 is a sequence diagram for explaining an example of operations, in association with each other, of the terminal device and the server device included in the positioning system according to the first example embodiment of the present invention.

FIG. 10 is a sequence diagram for explaining the operations, in association with each other, of the terminal device and the server device included in the positioning system according to the first example embodiment of the present invention.

FIG. 11 is a conceptual diagram illustrating a schematic configuration of a positioning system according to a second example embodiment of the present invention.

FIG. 12 is a block diagram illustrating an example of a configuration of a terminal device of the positioning system according to the second example embodiment of the present invention.

FIG. 13 is a conceptual diagram illustrating a schematic configuration of a positioning system according to a third example embodiment of the present invention.

FIG. 14 is a block diagram illustrating an example of a configuration of a terminal device of the positioning system according to the third example embodiment of the present invention.

FIG. 15 is a sequence diagram for explaining operations, in association with each other, of the terminal device and a server device included in the positioning system according to the third example embodiment of the present invention.

FIG. 16 is a block diagram illustrating an example of a configuration of a terminal device included in a positioning system according to related art.

FIG. 17 is a flowchart for explaining an example of an operation of the terminal device included in the positioning system according to the related art.

FIG. 18 is a block diagram illustrating an example of a hardware configuration for achieving processing functions of the terminal device and the server device included in the positioning system according to each example embodiment of the present invention.

### EXAMPLE EMBODIMENT

Hereinafter, example embodiments of the present invention will be described with reference to the drawings. However, although technically preferred limitation in order to implement the present invention is applied to the example embodiments described later, the scope of the invention is not limited as follows. In all the drawings used for description of the example embodiments below, the similar portion is denoted with the same reference numerals unless there is a particular reason. In the following example embodiments, repetitive description on similar configurations and operations may be omitted.

### First Example Embodiment

First, a positioning system according to a first example embodiment will be described with reference to the drawings. The positioning system according to the present example embodiment has a function for performing positioning by a positioning method using the Global Positioning System (hereinafter, referred to as GPS) method and a function for performing positioning by a positioning method other than the GPS method.

### Configuration

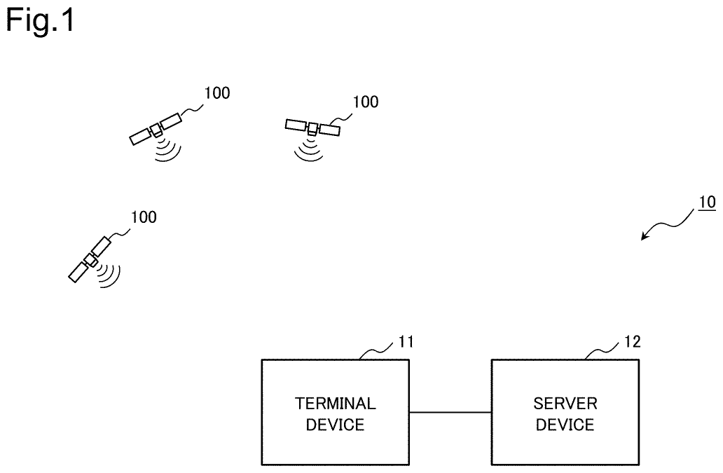

FIG. 1 is a block diagram illustrating a schematic configuration of a positioning system 10 according to the present example embodiment. As illustrated in FIG. 1, the positioning system 10 includes at least one terminal device 11 and a server device 12. In FIG. 1, a plurality of GPS satellites 100 that transmits GPS signals is illustrated. Although only the single terminal device 11 is illustrated in FIG. 1, the number of terminal devices 11 is not limited. Although the terminal device 11 and the server device 12 are wiredly connected, a positional relationship and a connection form of the terminal device 11 and the server device 12 are not particularly limited. For example, the terminal device 11 and the server device 12 are connected via a network such as the Internet, an intranet, or the like. The terminal device 11 and the server device 12 may be directly connected by a cable.

The terminal device 11 receives the GPS signals (also referred to first positioning signal) from the plurality of GPS satellites 100. The terminal device 11 calculates a distance to each satellite by using the GPS signals from the plurality of GPS satellites 100 and measures a position of the terminal device 11. That is, the terminal device 11 measures the position of the terminal device 11 by using a GPS method (also referred to as first positioning method).

The terminal device 11 measures the position of the terminal device 11 by a positioning method other than the GPS method (also referred to as second positioning method). For example, the terminal device 11 applies beacons of the Bluetooth (registered trademark), a Basic Service Set Identifier (BSSID) of the Wi-Fi (registered trademark), a terrestrial magnetism, or an ultrasonic wave as the positioning method other than the GPS method. The terminal device 11 may apply a Pedestrian Dead Reckoning (PDR) method that is a combination of these positioning methods. The positioning method used by the terminal device 11 is not limited to the above methods.

The terminal device 11 transmits a positioning result of the terminal device 11 (also referred to as primary positioning result) to the server device 12 via the network. The primary positioning result may be a result obtained by performing positioning using the GPS method or may be a result obtained by performing positioning using the positioning method other than the GPS method. The primary positioning result is data used to determine the positioning method of the terminal device 11 by the side of the server device 12.

The server device 12 receives the primary positioning result of the terminal device 11 via the network. The server device 12 determines the positioning method of the terminal device 11 by using the received primary positioning result. The server device 12 transmits a positioning method setting instruction used to set to the positioning method that is the determination result to the terminal device 11. In a case of determining that the position of the terminal device 11 is within a range of the GPS method, the server device 12 transmits a positioning method setting instruction for giving an instruction on use of the GPS method to the terminal device 11. On the other hand, in a case of determining that the position of the terminal device 11 is outside the range of the GPS method, the server device 12 transmits a positioning method setting instruction for giving an instruction on use of the positioning method other than the GPS method to the terminal device 11.

The terminal device 11 receives the positioning method setting instruction based on the primary positioning result of the terminal device 11 from the server device 12. In a case where the GPS method is specified, the terminal device 11 adopts the positioning method using the GPS signal. On the other hand, in a case where the positioning method other than the GPS method is specified, the terminal device 11 adopts the positioning method other than the GPS method.

The terminal device 11 outputs a positioning result regarding the position of the terminal device 11 measured by using the positioning method according to the positioning method setting instruction. For example, the terminal device 11 displays the positioning result on a monitor (not illustrated) or the like. For example, the terminal device 11 transmits the positioning result to the server device 12. For example, the terminal device 11 outputs the positioning result to an application installed to the terminal device 11. An output method of the positioning result by the terminal device 11 is not particularly limited. A timing when the terminal device 11 measures the position of the terminal device 11 may be a timing before the reception of the positioning method setting instruction from the server device 12 or may be a timing after the reception of the positioning method setting instruction from the server device 12.

The schematic configuration of the positioning system 10 has been described above. Subsequently, details of the terminal device 11 and the server device 12 included in the positioning system 10 will be described.

### Terminal Device

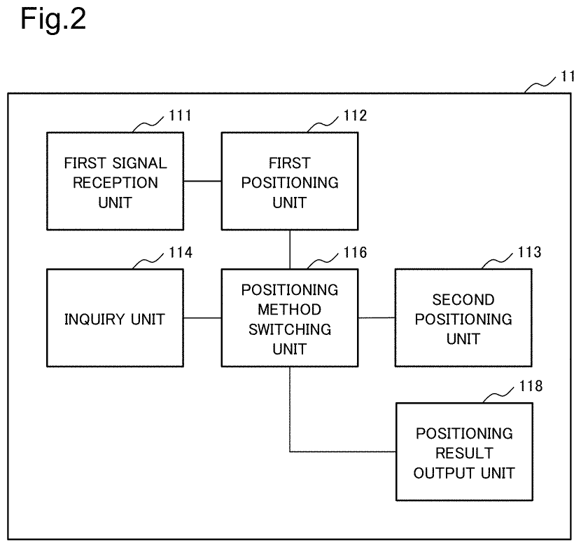

Next, the terminal device 11 of the positioning system 10 will be described with reference to the drawings. FIG. 2 is a block diagram illustrating an example of a configuration of the terminal device 11. As illustrated in FIG. 2, the terminal device 11 includes a first signal reception unit 111, a first positioning unit 112, a second positioning unit 113, an inquiry unit 114, a positioning method switching unit 116, and a positioning result output unit 118.

The first signal reception unit 111 receives radio waves (GPS signal) transmitted from the plurality of GPS satellites 100. The first signal reception unit 111 outputs the received GPS signal (also referred to as first signal) to the first positioning unit 112.

The first positioning unit 112 acquires the GPS signal from the first signal reception unit 111. The first positioning unit 112 calculates a distance to each GPS satellite 100 by using the acquired GPS signal and calculates the position of the terminal device 11 based on the distance to each satellite. That is, the first positioning unit 112 measures the position of the terminal device 11 by the GPS method. The first positioning unit 112 outputs a positioning result by the GPS method to the positioning method switching unit 116 in response to a request from the positioning method switching unit 116.

The second positioning unit 113 measures the position of the terminal device 11 by the positioning method other than the GPS method. For example, the second positioning unit 113 applies beacons of the Bluetooth, BSSID of the Wi-Fi, a terrestrial magnetism, or an ultrasonic wave as the positioning method other than the GPS method. The second positioning unit 113 may apply a PDR method that is a combination of these positioning methods. The positioning method used by the second positioning unit 113 is not limited to the above. The second positioning unit 113 outputs the positioning result by the positioning method other than the GPS method to the positioning method switching unit 116 in response to the request from the positioning method switching unit 116.

The inquiry unit 114 transmits a primary positioning result including position information (hereinafter, simply referred to as “position”) of the terminal device 11 to the server device 12. The inquiry unit 114 receives a positioning method according to the primary positioning result of the terminal device 11 from the server device 12.

The inquiry unit 114 receives a positioning method setting instruction based on the primary positioning result of the terminal device 11 from the server device 12. The inquiry unit 114 outputs the received positioning method setting instruction to the positioning method switching unit 116.

For example, the inquiry unit 114 transmits the positioning result of either one of the first positioning unit 112 or the second positioning unit 113 to the server device 12 as a primary positioning result. The inquiry unit 114 may transmit the positioning result by a unit other than the first positioning unit 112 and the second positioning unit 113 to the server device 12 as a primary positioning result. As long as the positioning method based on the position of the terminal device 11 can be determined, a positioning method and accuracy of the primary positioning result transmitted from the inquiry unit 114 to the server device 12 are not limited. The primary positioning result may be a positioning result that is not the latest within a range that does not affect the positioning of the terminal device 11.

The positioning method switching unit 116 acquires a positioning method setting instruction according to the primary positioning result from the inquiry unit 114. The positioning method switching unit 116 acquires a positioning result according to the acquired positioning method setting instruction from either one of the first positioning unit 112 or the second positioning unit 113. In a case where the positioning method is the GPS method, the positioning method switching unit 116 acquires the positioning result from the first positioning unit 112. In a case where the positioning method is a method other than the GPS, the positioning method switching unit 116 acquires the positioning result from the second positioning unit 113. The positioning method switching unit 116 outputs the acquired positioning result to the positioning result output unit 118.

The positioning result output unit 118 acquires the positioning result of the terminal device 11 from the positioning method switching unit 116. The positioning result output unit 118 outputs the acquired positioning result. For example, the positioning result output unit 118 displays the positioning result on a monitor (not illustrated) or the like. For example, the positioning result output unit 118 transmits the positioning result to the server device 12. For example, the positioning result output unit 118 outputs the positioning result to an application installed to the terminal device 11. An output method of the positioning result by the positioning result output unit 118 is not particularly limited.

The detailed configuration of the terminal device 11 has been described above. Subsequently, details of the configuration of the server device 12 will be described.

### Server Device

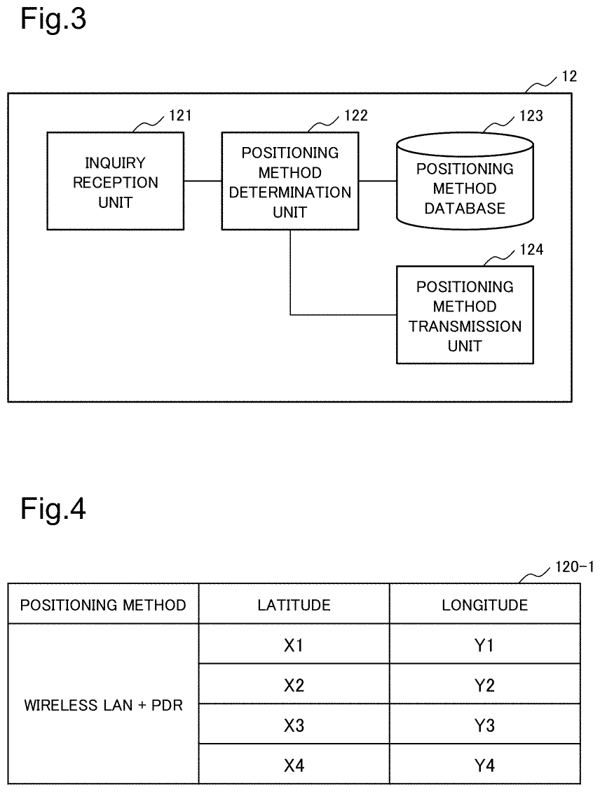

FIG. 3 is a block diagram illustrating an example of the configuration of the server device 12 of the positioning system 10. The server device 12 includes an inquiry reception unit 121, a positioning method determination unit 122, a positioning method database 123, and a positioning method transmission unit 124.

The inquiry reception unit 121 receives the primary positioning result from the terminal device 11. The inquiry reception unit 121 outputs the received primary positioning result to the positioning method determination unit 122.

The positioning method determination unit 122 acquires the primary positioning result from the inquiry reception unit 121. The positioning method determination unit 122 refers to the positioning method database 123 and acquires at least one positioning method related to the position of the terminal device 11 included in the acquired primary positioning result. The positioning method determination unit 122 outputs the acquired at least one positioning method to the positioning method transmission unit 124. In a case where there is the plurality of positioning methods related to the primary positioning result, the positioning method determination unit 122 may output the plurality of positioning methods.

The positioning method determination unit 122 may select some positioning methods related to the position of the terminal device 11 according to the position of the terminal device 11 included in the primary positioning result and may output the selected positioning methods to the positioning method transmission unit 124. In this case, the positioning method determination unit 122 may output some positioning methods in a list format. In a case where the plurality of positioning methods is listed, the positioning method determination unit 122 may set a priority for the positioning methods. For example, it is sufficient that priorities of a positioning method with low power consumption, a positioning method that can more surely perform positioning, a positioning method with a higher processing speed, or the like be set to be high.

The positioning method database 123 stores the positioning method linked to the position. For example, the positioning method database 123 stores coordinates of a vertex of a region in which the positioning method is set to the GPS method and coordinates of a vertex of a region in which the positioning method is set to the positioning method other than the GPS method. For example, the positioning method database 123 stores coordinates included in the region in which the positioning method is set to the GPS method and coordinates included in the region in which the positioning method is set to the positioning method other than the GPS method. However, data stored in the positioning method database 123 is not limited to those described above.

The positioning method transmission unit 124 acquires a positioning method setting instruction used to set at least one positioning method from the positioning method determination unit 122. The positioning method transmission unit 124 transmits the acquired positioning method setting instruction to the terminal device 11. For example, the positioning method transmission unit 124 transmits one positioning method related to the position of the terminal device 11 included in the primary positioning result to the terminal device 11. For example, the positioning method transmission unit 124 transmits data of a list of the plurality of positioning methods that can be used at the position of the terminal device 11 included in the primary result to the terminal device 11.

The details of the configuration of the server device 12 have been described above. Detailed configurations of the terminal device 11 and the server device 12 are not limited to those described above, and various changes and additions can be made.

### Positioning Method Setting Instruction

Here, an example of the positioning method setting instruction to be transmitted from the server device 12 to the terminal device 11 will be described with reference to the drawings.

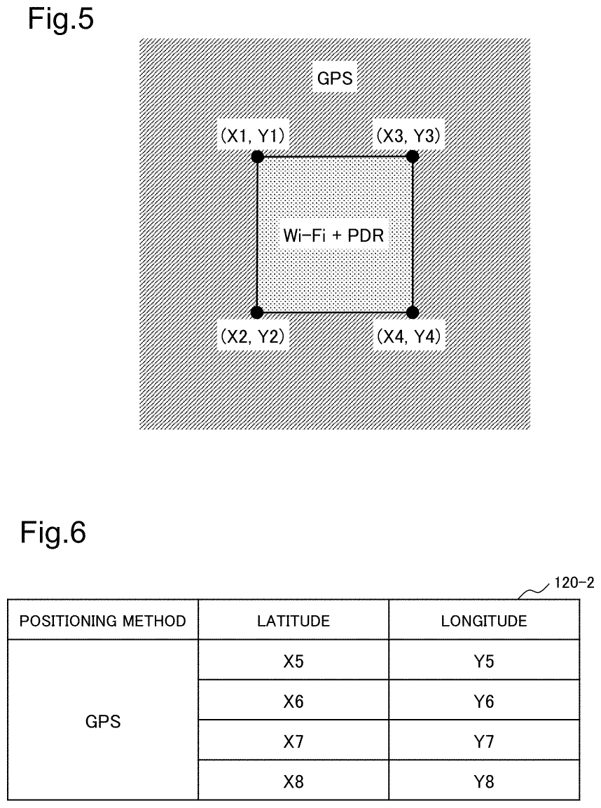

FIG. 4 is an example in which a positioning method list 120-1 including vertices of a positioning region (rectangle) measured by using the Wi-Fi and the PDR is transmitted from the server device 12 as the positioning method setting instruction. FIG. 5 is a conceptual diagram illustrating the vertices included in the positioning method list 120-1 in FIG. 4 as a rectangular region. In the example in FIG. 5, a state is illustrated where the positioning region using the Wi-Fi and the PDR method is included in a range of a positioning region using the GPS method.

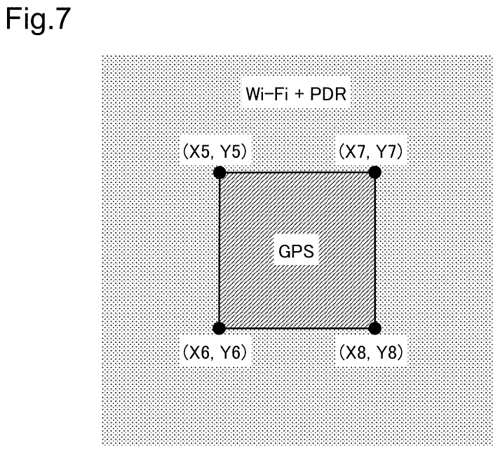

FIG. 6 is an example in which a positioning method list 120-2 including vertices of a positioning region (rectangle) measured by using the GPS method is transmitted from the server device 12 as the positioning method setting instruction. FIG. 7 is a conceptual diagram illustrating the vertices included in the positioning method list 120-2 in FIG. 6 as a rectangular region. In the example in FIG. 7, a state is illustrated where the positioning region using the GPS method is surrounded by the positioning region using the Wi-Fi and the PDR as the positioning method.

In a case where the terminal device 11 is positioned in the region using the GPS method, the terminal device 11 sets the GPS method as the positioning method. In a case where the terminal device 11 is positioned in the region using the Wi-Fi and the PDR, the terminal device 11 sets the Wi-Fi and the PDR as the positioning method. In a case where the terminal device 11 move across a boundary between the region using the Wi-Fi and the PDR and the region using the GPS method, the terminal device 11 switches the positioning methods.

When the terminal device 11 enters a certain positioning region, the terminal device 11 may set not to use the GPS method or not to use the Wi-Fi and the PDR. The shape of the positioning region is not limit to an inside of a rectangle, but may be set to an inside of a polygon such as a triangle, a quadrangle, or a pentagon or an inside of a closed curve such as an ellipse or a circle.

### Operation

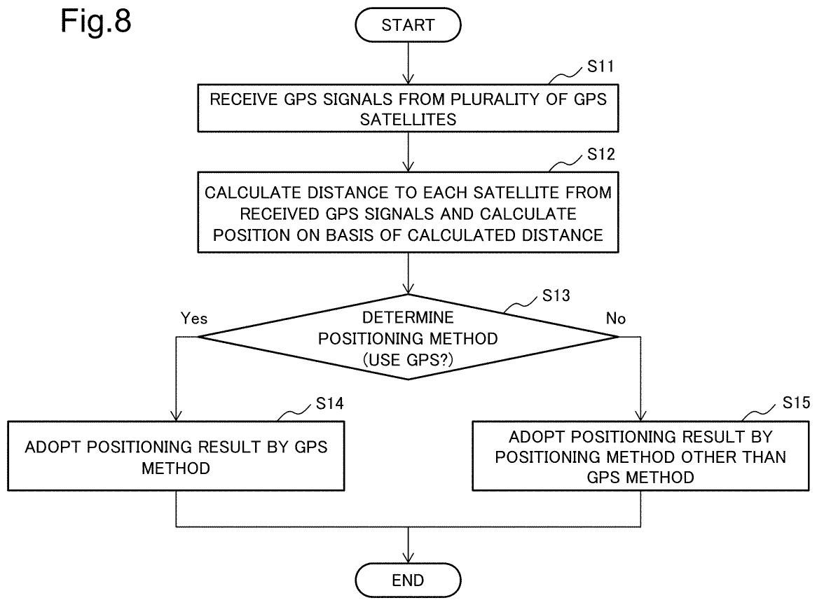

Next, an overall operation of the positioning system 10 will be described with reference to the drawings. FIG. 8 is flowchart for explaining the overall operation of the positioning system 10.

In FIG. 8, first, the positioning system 10 receives the GPS signal from the GPS satellite 100 (step S11). Note that it is assumed that the positioning system 10 be waiting for reception of the GPS signal in step S11.

Next, the positioning system 10 calculates the distance to each satellite from the received GPS signal and calculates the position of the terminal device 11 based on the calculated distance (step S12). That is, the positioning system 10 calculates the distance from each satellite to the terminal device 11 and calculates the position of the terminal device 11 based on the calculated distance between each GPS satellite 100 and the terminal device 11 and a position on an orbit of each satellite 100.

Next, the positioning system 10 determines the positioning method based on the calculated position of the terminal device 11 (step S13). At this time, the terminal device 11 transmits the primary positioning result including the position of the terminal device 11 to the server device 12 and inquires of the server device 12 about the positioning method. The server device 12 determines the positioning method according to the position of the terminal device 11 in response to the inquiry from the terminal device 11 and transmits the positioning method setting instruction to the terminal device 11.

In a case where the GPS method is used (Yes in step S13), the positioning system 10 adopts the positioning result by the GPS method (step S14). At this time, the terminal device 11 outputs the position of the terminal device 11 calculated by using the GPS method. The position of the terminal device 11 output by the terminal device 11 may be a value that has been calculated in advance or may be a value calculated after the positioning method is received.

On the other hand, in a case where the positioning method other than the GPS method is used (No in step S13), the positioning system 10 adopts the positioning result by the positioning method other than the GPS method (step S15). At this time, the terminal device 11 outputs the position of the terminal device 11 calculated by using the positioning method other than the GPS method. The position of the terminal device 11 output by the terminal device 11 may be a value that has been calculated in advance or may be a value calculated after the positioning method is received.

The overall operation of the positioning system 10 has been described above.

### First Operation Example

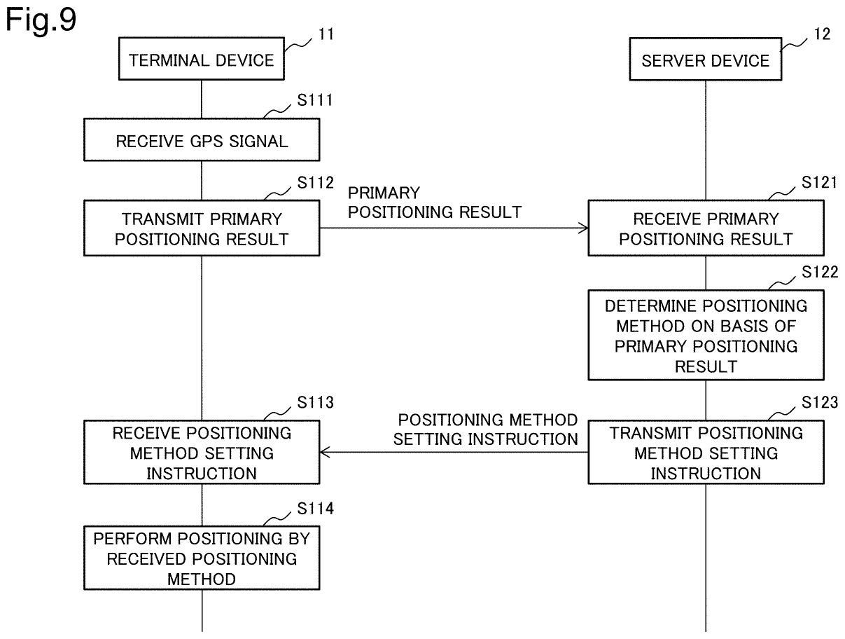

Next, a first operation example in which the operations of the terminal device 11 and the server device 12 included in the positioning system 10 are associated with each other will be described. FIG. 9 is a sequence diagram for explaining the first operation example.

In FIG. 9, first, the terminal device 11 receives the radio wave (GPS signal) from the GPS satellite 100 (step S111).

The terminal device 11 transmits the primary positioning result that is a result of positioning the position of the terminal device 11 by using the GPS signals received from the plurality of GPS satellites 100 to the server device 12 (step S112). The primary positioning result may be a result obtained by performing positioning by the positioning method other than the GPS method.

The server device 12 receives the primary positioning result from the terminal device 11 (step S121).

The server device 12 determines a positioning method at the position of the terminal device 11 based on the primary positioning result of the terminal device 11 (step S122).

The server device 12 transmits a positioning method setting instruction used to set the positioning method to the determined positioning method to the terminal device 11 (step S123).

The terminal device 11 receives the positioning method setting instruction from the server device 12 (step S113).

The terminal device 11 determines the position of the terminal device 11 according to the received positioning method setting instruction (step S114). The terminal device 11 may previously position the position of the terminal device 11 before receiving the positioning method setting instruction or may position the position of the terminal device 11 after receiving the positioning method setting instruction. The terminal device 11 may be configured to receive the positioning method at one point related to the primary positioning result or may acquire information regarding a range including the one point related to the primary positioning result. If the information regarding the range where a certain positioning method is adopted is acquired, the positioning method of the terminal device 11 can be set without making an inquiry from the terminal device 11 to the server device 12 as long as the terminal device 11 is positioned within the range.

The first operation example has been described above.

### Second Operation Example

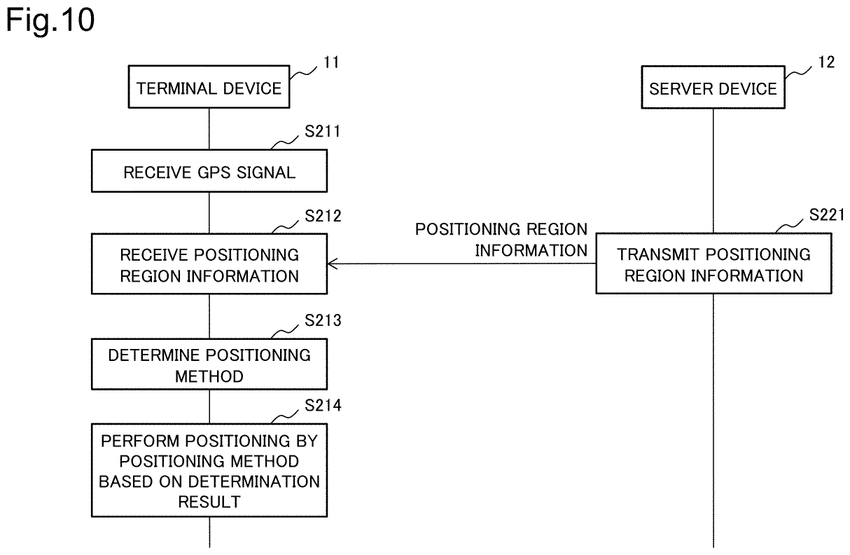

Next, a second operation example in which the operations of the terminal device 11 and the server device 12 included in the positioning system 10 are associated with each other will be described. FIG. 10 is a sequence diagram for explaining the second operation example. The second operation example is an example in which the server device 12 notifies the terminal device 11 of positioning region information indicating a range where a certain positioning method is used as a positioning method setting instruction without depending on whether an inquiry from the terminal device 11 is received.

In FIG. 10, first, the terminal device 11 receives the radio wave (GPS signal) from the GPS satellite 100 (step S211).

The server device 12 transmits the positioning region information to the terminal device 11 (step S221). For example, the server device 12 transmits the positioning region information to the terminal device 11 at a predetermined timing. For example, when detecting that the terminal device 11 enters an inside of a certain region, the server device 12 transmits the positioning region information to the terminal device 11.

For example, the server device 12 transmits, to the terminal device 11, the positioning region information regarding a positioning region including a current position of the terminal device 11. For example, the server device 12 transmits, to the terminal device 11, positioning region information including at least one positioning method linked to the positioning region including the current position of the terminal device 11. For example, when specifying the positioning region, the server device 12 may specify the positioning region by using coordinates of vertices of a polygon such as a rectangle, may specify the positioning region by using center coordinates and a radius of a circle, or may specify the positioning region by using a plurality of points on a curved line having a complicated shape. That is, the server device 12 specifies the positioning region by using a format that can uniquely specify the positioning region by both of the terminal device 11 and the server device 12.

The terminal device 11 receives the positioning region information from the server device 12 (step S212).

The terminal device 11 determines the positioning method according to whether the terminal device 11 is positioned within the region included in the positioning region information (step S213).

The terminal device 11 measures the position of the terminal device 11 based on the determination result of the positioning method (step S214). The terminal device 11 may previously position the position of the terminal device 11 before determining the positioning method or may position the position of the terminal device 11 after determining the positioning method. Because the terminal device 11 acquires information regarding a range where a certain positioning method is adopted, the terminal device 11 can set the positioning method of the terminal device 11 without making an inquiry from the terminal device 11 to the server device 12 as long as the terminal device 11 is positioned within the region.

The second operation example has been described above.

As described above, the positioning system according to the present example embodiment includes the server device and the at least one terminal device. The server device transmits, to the terminal device, the positioning method setting instruction to specify the positioning method based on the position of the terminal device. The terminal device measures the position of the terminal device by using the positioning method according to the positioning method setting instruction. The terminal device measures the position of the terminal device by using at least either one of the first positioning method using the first positioning signals transmitted from the plurality of satellites included in the global positioning system and the at least one second positioning method different from the first positioning method.

For example, the server device includes a database that stores the position in the positioning target region linked to the positioning method. The server device selects the positioning method related to the position of the terminal device from the database and transmits, to the terminal device, the positioning method setting instruction used to specify the selected positioning method to the terminal device.

For example, the terminal device transmits the primary positioning result including the position of the terminal device to the server device. The server device receives the primary positioning result, selects the positioning method related to the position of the terminal device included in the received primary positioning result from the database, and transmits the positioning method setting instruction used to specify the selected positioning method to the terminal device.

For example, the server device acquires the position of the terminal device via the network, selects the positioning method related to the acquired position of the terminal device from the database, and transmits the positioning method setting instruction to specify the selected positioning method to the terminal device.

For example, the server device transmits the positioning method setting instruction including coordinates defining the positioning region linked to the positioning method to the terminal device. The terminal device sets the positioning method based on a specific positioning region defined by the coordinates included in the positioning method setting instruction coordinates and the position of the terminal device.

For example, the terminal device includes reception means, first positioning means, second positioning means, inquiry means, positioning method switching means, and positioning result output means.

For example, the reception means receives the first positioning signal. The first positioning means measures the position of the terminal device by the first positioning method using the first positioning signal. The second positioning means measures the position of the terminal device by the at least one second positioning method. The inquiry means transmits the primary positioning result including the position of the terminal device to the server device and receives the positioning method setting instruction according to the primary positioning result from the server device. The positioning method switching means selects the positioning result measured by the positioning method based on the positioning method setting instruction received by the inquiry means. The positioning result output means outputs the positioning result selected by the positioning method switching means.

For example, the server device includes inquiry reception means, positioning method determination means, and positioning method setting instruction transmission means. The inquiry reception means receives the primary positioning result from the terminal device. The positioning method determination means refers to the database and selects the positioning method of the terminal device related to the position of the terminal device included in the received primary positioning result. The positioning method setting instruction transmission means transmits the positioning method setting instruction used to specify the positioning method selected by the positioning method determination means to the terminal device.

In the present example embodiment, an instruction to change the positioning method to the positioning method other than the GPS method can be uniformly transmitted from the server device to the terminal device that enters a region having a large positioning error caused by the reflected wave of the GPS signal as in an area where a large number of tall buildings are built or an inside of a building. In the present example embodiment, the instruction to change the positioning method to the GPS method can be uniformly transmitted from the server device to the terminal device when the terminal device, which performs positioning by using the positioning method other than the GPS method, enters a region with high positioning accuracy by the GPS method.

According to the present example embodiment, by specifying the positioning method of the terminal device by the server device, the terminal device can switch the positioning method before the positioning method becomes inappropriate. Therefore, deterioration in positioning accuracy can be suppressed. According to the present example embodiment, by switching the GPS method and the positioning method other than the GPS method according to a magnitude of an error in each positioning method, more accurate positioning, which cannot be obtained by the positioning method using the GPS method alone, can be achieved at various places.

That is, according to the present example embodiment, the positioning system can be provided that can achieve continuous positioning without depending on the reception state of the radio waves transmitted from the satellites included in the global positioning system.

### Second Example Embodiment

Next, a positioning system according to a second example embodiment of the present invention will be described with reference to the drawings. The positioning system according to the present example embodiment is different from that in the first example embodiment in that the terminal device and the server device wirelessly communicate with each other.

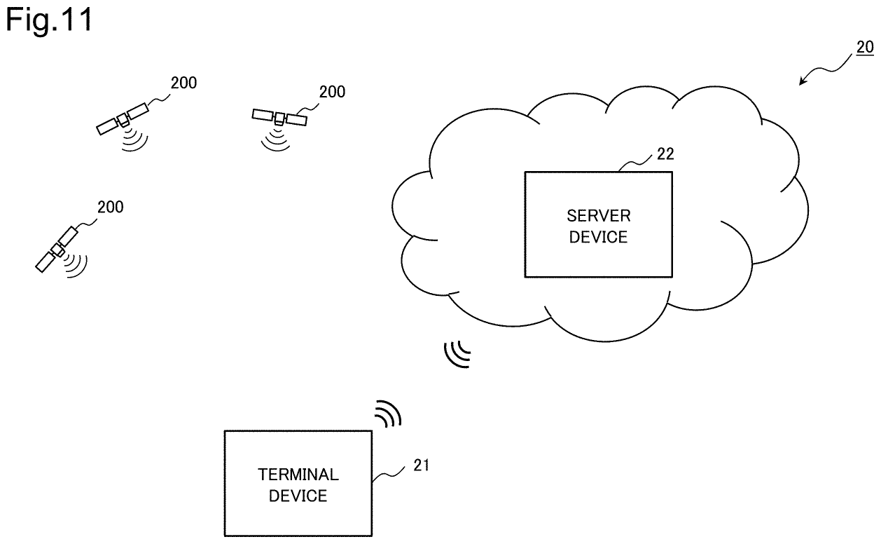

FIG. 11 is a conceptual diagram illustrating a schematic configuration of a positioning system 20 according to the present example embodiment. As illustrated in FIG. 11, the positioning system 20 includes at least one terminal device 21 and a server device 22. In FIG. 11, a plurality of GPS satellites 200 that transmits GPS signals is illustrated. Although only the single terminal device 21 is illustrated in FIG. 11, the number of terminal devices 21 is not limited. Although the terminal device 21 and the server device 22 are wirelessly connected, a positional relationship and a connection form of the terminal device 21 and the server device 22 are not particularly limited. For example, the terminal device 21 and the server device 22 are connected via a network such as the Internet, an intranet, or the like by wireless communication.

The terminal device 21 receives the GPS signals (also referred to first positioning signal) from the plurality of GPS satellites 200. The terminal device 21 calculates a distance to each satellite by using the GPS signals from the plurality of GPS satellites 200 and measures a position of the terminal device 21. That is, the terminal device 21 measures the position of the terminal device 21 by using a GPS method (also referred to as first positioning method). The terminal device 21 measures the position of the terminal device 21 by a positioning method other than the GPS method (also referred to as second positioning method).

The terminal device 21 wirelessly transmits a positioning result of the terminal device 21 (also referred to as primary positioning result) to the server device 22.

The server device 22 receives the primary positioning result of the terminal device 21 via the network. For example, the server device 22 is installed in a data center or the like and receives the primary positioning result via a wireless communication device (not illustrated) connected to the server device 22.

The server device 22 determines the positioning method of the terminal device 21 by using the received primary positioning result. The server device 22 transmits a positioning method setting instruction used to set to the positioning method that is the determination result to the terminal device 21. In a case of determining that the position of the terminal device 21 is within a range of the GPS method, the server device 22 transmits a positioning method setting instruction for giving an instruction on use of the GPS method to the terminal device 21. On the other hand, in a case of determining that the position of the terminal device 21 is outside the range of the GPS method, the server device 22 transmits a positioning method setting instruction for giving an instruction on use of the positioning method other than the GPS method to the terminal device 21.

The terminal device 21 receives the positioning method setting instruction based on the primary positioning result of the terminal device 21 from the server device 22. In a case where the GPS method is specified, the terminal device 21 adopts the positioning method using the GPS signal. On the other hand, in a case where the positioning method other than the GPS method is specified, the terminal device 21 adopts the positioning method other than the GPS method.

The terminal device 21 outputs a positioning result regarding the position of the terminal device 21 measured by using the positioning method based on the positioning method setting instruction. For example, the terminal device 21 displays the positioning result on a monitor (not illustrated) or the like. For example, the terminal device 21 transmits the positioning result to the server device 22. For example, the terminal device 21 outputs the positioning result to an application installed to the terminal device 21. An output method of the positioning result by the terminal device 21 is not particularly limited. A timing when the terminal device 21 measures the position of the terminal device 21 may be before the reception of the positioning method from the server device 22 or may be after the reception of the positioning method from the server device 22.

The schematic configuration of the positioning system 20 has been described above. Subsequently, details of the terminal device 21 included in the positioning system 20 will be described.

### Terminal Device

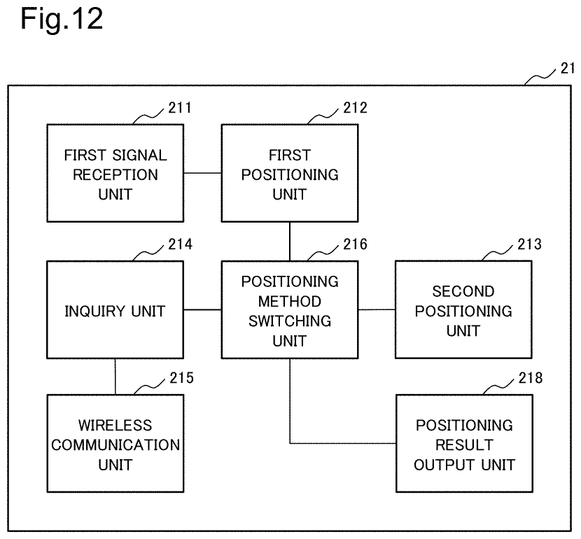

Next, the terminal device 21 of the positioning system 20 will be described with reference to the drawings. FIG. 12 is a block diagram illustrating an example of a configuration of the terminal device 21. As illustrated in FIG. 12, the terminal device 21 includes a first signal reception unit 211, a first positioning unit 212, a second positioning unit 213, an inquiry unit 214, a wireless communication unit 215, a positioning method switching unit 216, and a positioning result output unit 218.

The first signal reception unit 211 receives radio waves (GPS signal) transmitted from the plurality of GPS satellites 200. The first signal reception unit 211 outputs the received GPS signal (also referred to as first signal) to the first positioning unit 212.

The first positioning unit 212 acquires the GPS signal from the first signal reception unit 211. The first positioning unit 212 calculates a distance to each GPS satellite 200 by using the acquired GPS signal and calculates the position of the terminal device 21 based on the distance to each satellite. That is, the first positioning unit 212 measures the position of the terminal device 21 by the GPS method. The first positioning unit 212 outputs a positioning result by the GPS method to the positioning method switching unit 216 in response to a request from the positioning method switching unit 216.

The second positioning unit 213 measures the position of the terminal device 21 by the positioning method other than the GPS method. For example, the second positioning unit 213 applies beacons of the

Bluetooth, BSSID of the Wi-Fi, a terrestrial magnetism, or an ultrasonic wave as the positioning method other than the GPS method. The second positioning unit 213 may apply a PDR method that is a combination of these positioning methods. The positioning method used by the second positioning unit 213 is not limited to the above. The second positioning unit 213 outputs the positioning result by the positioning method other than the GPS method to the positioning method switching unit 216 in response to the request from the positioning method switching unit 216.

The inquiry unit 214 outputs the primary positioning result including position information (hereinafter, simply referred to as “position”) of the terminal device 21 to the wireless communication unit 215. For example, the inquiry unit 214 transmits the positioning result of either one of the first positioning unit 212 or the second positioning unit 213 to the wireless communication unit 215 as a primary positioning result. The inquiry unit 214 may transmit the positioning result by a unit other than the first positioning unit 212 and the second positioning unit 213 to the server device 22 as a primary positioning result. As long as the positioning method based on the position of the terminal device 21 can be determined, a positioning method and accuracy of the primary positioning result are not limited. The primary positioning result may be a positioning result that is not the latest within a range that does not affect the positioning of the terminal device 21.

The inquiry unit 214 acquires a positioning method setting instruction based on the primary positioning result of the terminal device 21 from the wireless communication unit 215. The inquiry unit 214 outputs the acquired positioning method setting instruction to the positioning method switching unit 216.

The wireless communication unit 215 acquires the primary positioning result from the inquiry unit 214. The wireless communication unit 215 transmits the primary positioning result from the inquiry unit 214 to the server device 22 through a wireless line.

The wireless communication unit 215 receives the positioning method setting instruction according to the primary positioning result from the server device 22 via the wireless line. The wireless communication unit 215 outputs the received positioning method to the inquiry unit 214.

The positioning method switching unit 216 acquires a positioning method setting instruction according to the primary positioning result from the inquiry unit 214. The positioning method switching unit 216 acquires a positioning result according to the acquired positioning method setting instruction from either one of the first positioning unit 212 or the second positioning unit 213. In a case where the positioning method is the GPS method, the positioning method switching unit 216 acquires the positioning result from the first positioning unit 212. In a case where the positioning method is the method other than the GPS, the positioning method switching unit 216 acquires the positioning result from the second positioning unit 213. The positioning method switching unit 216 outputs the acquired positioning result to the positioning result output unit 218.

The positioning result output unit 218 acquires the positioning result of the terminal device 21 from the positioning method switching unit 216. The positioning result output unit 218 outputs the acquired positioning result. For example, the positioning result output unit 218 displays the positioning result on a monitor (not illustrated) or the like. For example, the positioning result output unit 218 transmits the positioning result to the server device 12. For example, the positioning result output unit 218 outputs the positioning result to an application installed to the terminal device 21. An output method of the positioning result by the positioning result output unit 218 is not particularly limited.

The detailed configuration of the terminal device 21 has been described above. Because the server device 22 is similar to the server device 12 of the positioning system 10 according to the first example embodiment, detailed description of the server device 22 will be omitted.

As described above, in the positioning system according to the present example embodiment, the terminal device includes the wireless communication means that can be wirelessly connected to the network connected to the server device. In the positioning system according to the present example embodiment, the terminal device can communicate with the server device by using the wireless communication, a degree of freedom of a positional relationship between the terminal device and the server device increases. Therefore, the positioning system according to the present example embodiment is suitable for configuring the terminal device by a portable terminal such as a smartphone or a tablet.

That is, according to the present example embodiment, continuous positioning can be achieved without depending on the reception state of the radio waves transmitted from the satellites included in the global positioning system.

### Third Example Embodiment

Next, a positioning system according to a third example embodiment of the present invention will be described with reference to the drawings. The positioning system according to the present example embodiment is different from those of the first and second example embodiments in that the positioning method of the terminal device is switched in accordance with a positioning method setting instruction from a beacon that has been installed in advance at a place where the positioning method is switched to the method other than the GPS method.

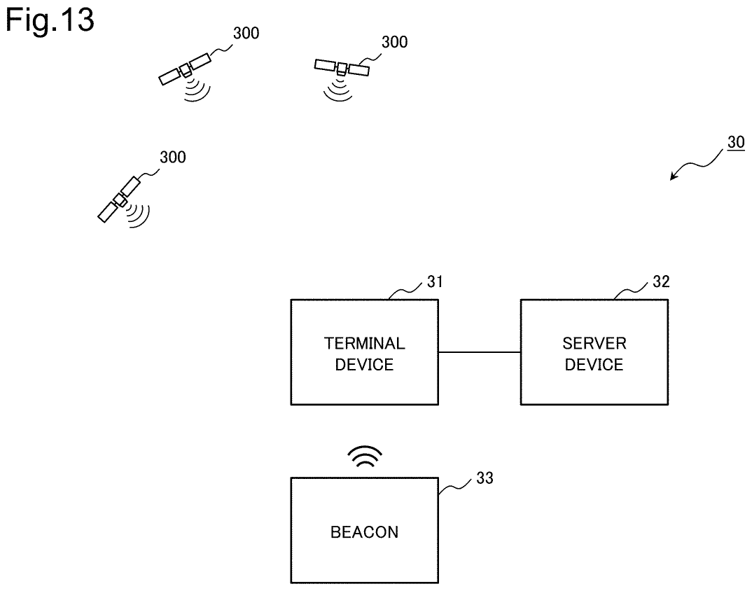

FIG. 13 is a conceptual diagram illustrating a schematic configuration of a positioning system 30 according to the present example embodiment. As illustrated in FIG. 13, the positioning system 30 includes at least one terminal device 31, a server device 32, and at least one beacon 33. In FIG. 13, a plurality of GPS satellites 300 that transmits GPS signals is illustrated. Although only the single terminal device 31 and the single beacon 33 are illustrated in FIG. 13, the number of terminal devices 31 and the number of beacons 33 are not limited. Although the terminal device 31 and the server device 32 are illustrated to be wiredly connected, the terminal device 31 and the server device 32 may be wirelessly connected to each other, and a positional relationship and a connection form of these devices are not particularly limited. For example, the terminal device 31 and the server device 32 are connected via a network such as the Internet, an intranet, or the like.

The terminal device 31 receives the GPS signals (also referred to first positioning signal) from the plurality of GPS satellites 300. The terminal device 31 calculates a distance to each satellite by using the GPS signals from the plurality of GPS satellites 300 and measures a position of the terminal device 31. That is, the terminal device 31 measures the position of the terminal device 31 by using a GPS method (also referred to as first positioning method).

The terminal device 31 measures the position of the terminal device 31 by a positioning method other than the GPS method (also referred to as second positioning method). For example, the terminal device 31 applies beacons of the Bluetooth (registered trademark), a Basic Service Set Identifier (BSSID) of the Wi-Fi (registered trademark), a terrestrial magnetism, or an ultrasonic wave as the positioning method other than the GPS method. The terminal device 31 may apply a Pedestrian Dead Reckoning (PDR) method that is a combination of these positioning methods. The positioning method used by the terminal device 31 is not limited to the above methods.

The terminal device 31 transmits a positioning result of the terminal device 31 (also referred to as primary positioning result) to the server device 32 via the network. The primary positioning result may be a result obtained by performing positioning using the GPS method or may be a result obtained by performing positioning using the positioning method other than the GPS method. The primary positioning result is data used to determine the positioning method of the terminal device 31 by the side of the server device 32.

The server device 32 receives the primary positioning result of the terminal device 31 via the network. The server device 32 determines the positioning method of the terminal device 31 by using the received primary positioning result. The server device 32 transmits a positioning method setting instruction used to set to the positioning method that is the determination result to the terminal device 31. In a case of determining that the position of the terminal device 31 is within a range where the GPS method is set, the server device 32 transmits a positioning method setting instruction for giving an instruction on use of the GPS method to the terminal device 31. On the other hand, in a case of determining that the position of the terminal device 31 is outside the range of the GPS method, the server device 32 transmits a positioning method setting instruction for giving an instruction on use of the positioning method other than the GPS method to the terminal device 31.

The terminal device 31 receives the positioning method setting instruction based on the primary positioning result of the terminal device 21 from the server device 32. In a case where the GPS method is specified, the terminal device 31 adopts the positioning method using the GPS signal. On the other hand, in a case where the positioning method other than the GPS method is specified, the terminal device 31 adopts the positioning method other than the GPS method.

The terminal device 31 outputs a positioning result regarding the position of the terminal device 31 measured by using the positioning method based on the positioning method setting instruction. For example, the terminal device 31 displays the positioning result on a monitor (not illustrated) or the like. For example, the terminal device 31 transmits the positioning result to the server device 32. For example, the terminal device 31 outputs the positioning result to an application installed to the terminal device 31. An output method of the positioning result by the terminal device 31 is not particularly limited. A timing when the terminal device 31 measures the position of the terminal device 31 may be a timing before the reception of the positioning method setting instruction from the server device 32 or may be a timing after the reception of the positioning method setting instruction from the server device 32.

The beacon 33 (also referred to as second signal transmission device) is disposed at least either in or around the positioning region measured by the positioning method other than the GPS method. The beacon 33 transmits the positioning method setting instruction. The positioning method setting instruction transmitted by the beacon 33 is transmitted at least at an intensity of radio wave received by the terminal device 31 in the positioning region measured by the positioning method other than the GPS method.

The beacon 33 can transmit the positioning method setting instruction at any timing. For example, the beacon 33 transmits the positioning method setting instruction at a predetermined time interval. For example, the beacon 33 transmits the positioning method setting instruction at a timing when it is detected that the terminal device 31 enters an area. For example, the beacon 33 transmits the positioning method setting instruction in accordance with control by the server device 32.

The terminal device 31 receives the positioning method setting instruction transmitted by the beacon 33. When receiving the positioning method setting instruction, the terminal device 31 performs positioning by the positioning method according to the positioning method setting instruction. For example, in a case where positioning is performed by using the GPS method, the terminal device 31 switches the positioning method to the positioning method other than the GPS method according to the positioning method setting instruction. For example, in a case where positioning is performed by using the positioning method other than the GPS method, the terminal device 31 maintains the positioning method other than the GPS method even when receiving the positioning method setting instruction. A priority to change the positioning method by the terminal device 31 is preferably set to one of the positioning method specified from the server device 32 or the positioning method setting instruction transmitted from the beacon 33.

The schematic configuration of the positioning system 30 has been described above. Subsequently, details of the terminal device 31 included in the positioning system 30 will be described.

### Terminal Device

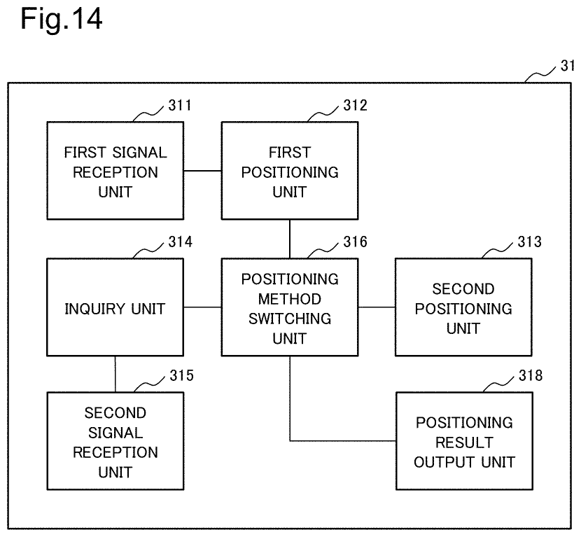

Next, the terminal device 31 of the positioning system 30 will be described with reference to the drawings. FIG. 14 is a block diagram illustrating an example of a configuration of the terminal device 31. As illustrated in FIG. 14, the terminal device 31 includes a first signal reception unit 311, a first positioning unit 312, a second positioning unit 313, an inquiry unit 314, a second signal reception unit 315, a positioning method switching unit 316, and a positioning result output unit 318.

The first signal reception unit 311 receives radio waves (GPS signal) transmitted from the plurality of GPS satellites 300. The first signal reception unit 311 outputs the received GPS signal (also referred to as first signal) to the first positioning unit 312.

The first positioning unit 312 acquires the GPS signal from the first signal reception unit 311. The first positioning unit 312 calculates a distance to each GPS satellite 300 by using the acquired GPS signal and calculates the position of the terminal device 31 based on the distance to each satellite. That is, the first positioning unit 312 measures the position of the terminal device 31 by the GPS method. The first positioning unit 312 outputs a positioning result by the GPS method to the positioning method switching unit 316 in response to a request from the positioning method switching unit 316.

The second positioning unit 313 measures the position of the terminal device 31 by the positioning method other than the GPS method. For example, the second positioning unit 313 applies beacons of the Bluetooth, BSSID of the Wi-Fi, a terrestrial magnetism, or an ultrasonic wave as the positioning method other than the GPS method. The second positioning unit 313 may apply a PDR method that is a combination of these positioning methods. The positioning method used by the second positioning unit 313 is not limited to the above. The second positioning unit 313 outputs the positioning result by the positioning method other than the GPS method to the positioning method switching unit 316 in response to the request from the positioning method switching unit 316.

The inquiry unit 314 outputs the primary positioning result including the position information (hereinafter, simply referred to as “position”) of the terminal device 31 to the second signal reception unit 315. For example, the inquiry unit 314 transmits the positioning result of either one of the first positioning unit 312 and the second positioning unit 313 to the second signal reception unit 315 as a primary positioning result. The inquiry unit 314 may transmit the positioning result by a unit other than the first positioning unit 312 and the second positioning unit 313 to the server device 22 as a primary positioning result. As long as the positioning method based on the position of the terminal device 31 can be determined, a positioning method and accuracy of the primary positioning result are not limited. The primary positioning result may be a positioning result that is not the latest within a range that does not affect the positioning of the terminal device 31.

The inquiry unit 314 acquires a positioning method according to the primary positioning result from the second signal reception unit 315. The inquiry unit 314 outputs the acquired positioning method to the positioning method switching unit 316.

Moreover, the inquiry unit 314 receives the positioning method setting instruction from the second signal reception unit 315. The inquiry unit 314 outputs the received positioning method setting instruction to the positioning method switching unit 316.

The second signal reception unit 315 receives the positioning method setting instruction transmitted from the beacon 33. The second signal reception unit 315 outputs the positioning method setting instruction from the beacon 33 to the inquiry unit 314.

The positioning method switching unit 316 acquires a positioning method setting instruction according to the primary positioning result from the inquiry unit 314. The positioning method switching unit 316 acquires a positioning result according to the acquired positioning method setting instruction from either one of the first positioning unit 312 or the second positioning unit 313. In a case where the positioning method is the GPS method, the positioning method switching unit 316 acquires the positioning result from the first positioning unit 312. In a case where the positioning method is the method other than the GPS, the positioning method switching unit 316 acquires the positioning result from the second positioning unit 313. The positioning method switching unit 316 outputs the acquired positioning result to the positioning result output unit 318.

The positioning method switching unit 316 acquires the positioning method setting instruction from the beacon 33 from the inquiry unit 314. When acquiring the positioning method setting instruction, the positioning method switching unit 316 outputs the positioning result acquired by the positioning method other than the GPS method to the positioning result output unit 318. For example, in a case where the terminal device 11 performs positioning by the GPS method, the positioning method switching unit 316 outputs the positioning result measured by the positioning method other than the GPS method by the second positioning unit 313 as switching a destination to the positioning result output unit 318. For example, in a case where the terminal device 11 performs positioning by the positioning method other than the GPS method, the positioning method switching unit 316 outputs the positioning result measured by the positioning method other than the GPS method by the second positioning unit 313 continuously to the positioning result output unit 318.

The positioning result output unit 318 acquires the positioning result of the terminal device 31 from the positioning method switching unit 316. The positioning result output unit 318 outputs the acquired positioning result. For example, the positioning result output unit 318 displays the positioning result on a monitor (not illustrated) or the like. For example, the positioning result output unit 318 transmits the positioning result to the server device 12. For example, the positioning result output unit 318 outputs the positioning result to an application installed to the terminal device 31. An output method of the positioning result by the positioning result output unit 318 is not particularly limited.

The detailed configuration of the terminal device 31 has been described above. Because the server device 22 is similar to the server device 12 of the positioning system 10 according to the first example embodiment, detailed description of the server device 22 will be omitted.

### Third Operation Example

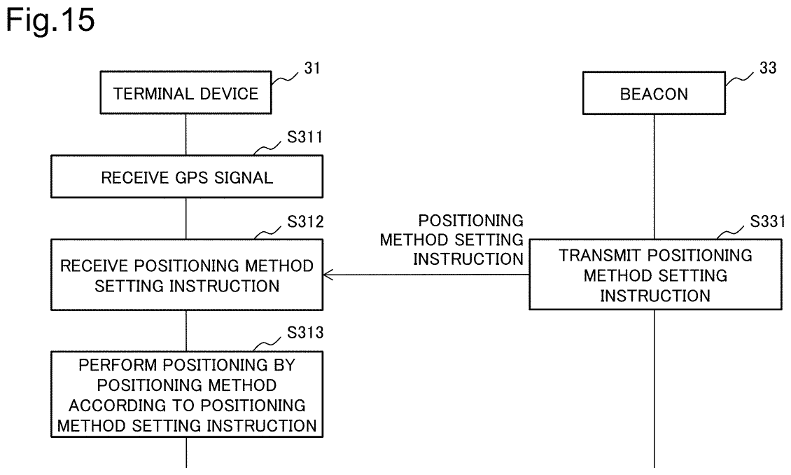

Next, a third operation example in which operations of the terminal device 31 and the beacon 33 included in the positioning system 30 are associated with each other will be described. FIG. 15 is a sequence diagram for explaining the third operation example. Because the operations of the terminal device 31 and the server device 32 are associated with each other by the first operation example and the second operation example according to the first example embodiment, description thereof will be omitted here.

In FIG. 15, first, the terminal device 31 receives the radio wave (GPS signal) from the GPS satellite 300 (step S311).

Here, the beacon 33 transmits the positioning method setting instruction (step S331). A timing when the beacon 33 transmits the positioning method setting instruction is optionally set. For example, the beacon 33 transmits the positioning method setting instruction at a predetermined time interval. For example, the beacon 33 transmits the positioning method setting instruction at a timing when it is detected that the terminal device 31 enters an area. For example, the beacon 33 transmits the positioning method setting instruction in accordance with control by the server device 32.

When the terminal device 31 enters a reception area of the positioning method setting instruction from the beacon 33, the terminal device 31 receives the positioning method setting instruction (step S312).

When receiving the positioning method setting instruction, the terminal device 31 performs positioning by the positioning method according to the positioning method setting instruction (step S313).

The third operation example has been described above.

As described above, the positioning system according to the present example embodiment includes the beacon that transmits the positioning method setting instruction for specifying a positioning method in a specific region. The terminal device receives the positioning method setting instruction from the beacon in addition to the positioning method from the server device and outputs the positioning result by the positioning method according to the positioning method setting instruction.

For example, if the positioning method setting instruction for setting the positioning method to the positioning method other than the GPS method is transmitted from the beacon when the server device and the beacon detect that the terminal device reaches an entrance of a building or the like, it is possible to set the positioning method of the terminal device to the positioning method other than the GPS method in the building. Therefore, even in a scene where accuracy is deteriorated in positioning by the GPS method, positioning by a positioning method with high accuracy other than the GPS method can be continued.

That is, according to the present example embodiment, continuous positioning can be achieved without depending on the reception state of the radio waves transmitted from the satellites included in the global positioning system.

### Related Art

Here, a positioning system according to related art will be described with reference to the drawings. The positioning system according to related art measures a position of a terminal device based on GPS signals from a plurality of GPS satellites (not illustrated).

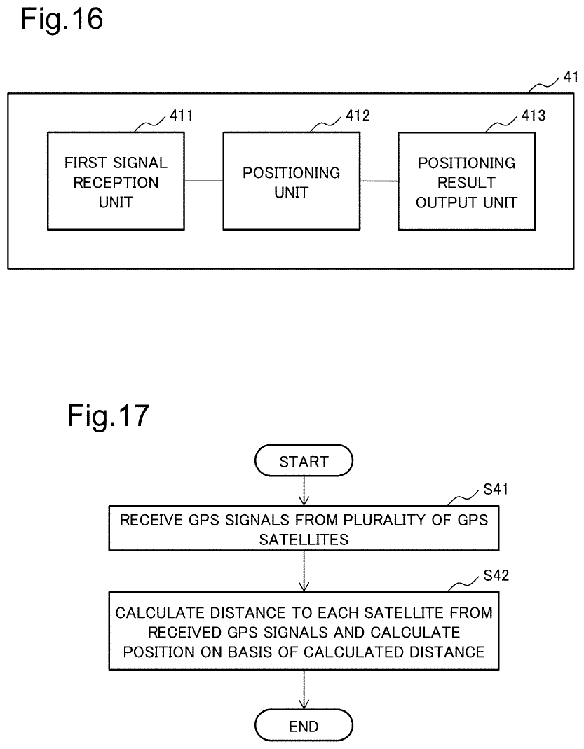

FIG. 16 is a block diagram illustrating an example of a terminal device 41 included in the positioning system according to related art. As illustrated in FIG. 16, the terminal device 41 includes a first signal reception unit 411, a positioning unit 412, and a positioning result output unit 413.

The first signal reception unit 411 receives radio waves (GPS signal) transmitted from the plurality of GPS satellites. The first signal reception unit 411 outputs the received GPS signal (also referred to as first signal) to the positioning unit 412.

The positioning unit 412 acquires the GPS signal from the first signal reception unit 411. The positioning unit 412 calculates a distance to each GPS satellite by using the acquired GPS signal and calculates a position of the terminal device 41 based on the distance to each satellite. That is, the positioning unit 412 measures the position of the terminal device 41 by a GPS method. The positioning unit 412 outputs the positioning result by the GPS method to the positioning result output unit 413.

The positioning result output unit 413 acquires the positioning result of the terminal device 41 from the positioning unit 412. The positioning result output unit 413 outputs the acquired positioning result.

The detailed configuration of the terminal device 41 has been described above.

Next, an operation regarding positioning of the terminal device 41 included in the positioning system according to related art will be described with reference to the flowchart in FIG. 17.

In FIG. 17, first, the terminal device 41 receives the GPS signals from the plurality of GPS satellites (step S41).

Next, the terminal device 41 calculates a distance to each satellite from the received GPS signals and calculates a position of the terminal device 41 based on the calculated distance (step S42).

The operation regarding positioning of the terminal device 41 included in the positioning system according to related art has been described above.

As described above, in the positioning system according to related art, the position of the terminal device 41 is measured by the GPS method regardless of the position of the terminal device 41. Therefore, when the terminal device 41 is positioned outside an area where the GPS signal reaches, it is not possible to measure the accurate position of the terminal device 41. For example, it is possible to switch the positioning method to the positioning method other than the GPS method after the terminal device 41 is positioned outside the area where the GPS signal reaches. However, in that case, positioning cannot be temporarily performed in a time period when the positioning method is switched. For example, although it is possible to change the positioning method by the terminal device 41 before the terminal device 41 is positioned outside the area where the GPS signal reaches, there is a case where settings are manually changed or settings are unnecessarily changed.

On the other hand, according to the positioning system according to each example embodiment of the present invention, it is possible to change the positioning method of the terminal device according to the instructions from the server device and the beacon. Therefore, it is possible to achieve continuous positioning without depending on a reception state of the GPS signal.

### Hardware

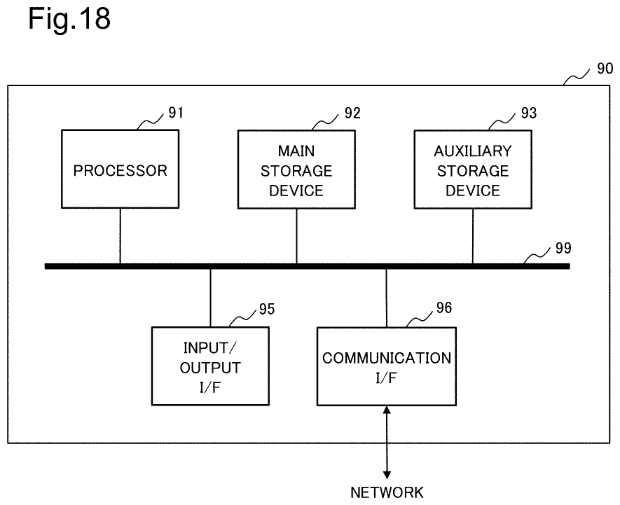

Here, a hardware configuration that executes processing by the terminal device and the server device included in the positioning system according to each example embodiment of the present invention will be described using an information processing apparatus 90 in FIG. 18 as an example. The information processing apparatus 90 in FIG. 18 is an exemplary configuration that executes the processing by the terminal device and the server device according to each example embodiment and does not limit the scope of the present invention.

As illustrated in FIG. 18, the information processing apparatus 90 includes a processor 91, a main storage device 92, an auxiliary storage device 93, an input/output interface 95, and a communication interface 96. In FIG. 18, an interface is abbreviated and expressed as an I/F (Interface). The processor 91, the main storage device 92, the auxiliary storage device 93, the input/output interface 95, and the communication interface 96 are connected to each other via a bus 99 in such a way as to perform data communication. The processor 91, the main storage device 92, the auxiliary storage device 93, and the input/output interface 95 are connected to a network such as the Internet or an intranet via the communication interface 96.

The processor 91 develops a program stored in the auxiliary storage device 93 and the like to the main storage device 92 and executes the developed program. In the present example embodiment, it is sufficient to use a configuration using a software program installed in the information processing apparatus 90. The processor 91 executes the processing by the terminal device and the server device according to the present example embodiment.

The main storage device 92 has a region where the program is developed. It is only required for the main storage device 92 to be, for example, a volatile memory such as a Dynamic Random Access Memory (DRAM). A nonvolatile memory such as a Magnetoresistive Random Access Memory (MRAM) may be configured and added as the main storage device 92.

The auxiliary storage device 93 stores various data. The auxiliary storage device 93 includes a hard disk and a local disk such as a flash memory. It is possible that the main storage device 92 stores various data and the auxiliary storage device 93 is omitted.

The input/output interface 95 is an interface that connects the information processing apparatus 90 to peripheral devices. The communication interface 96 is an interface that connects to an external system or device through the network such as the Internet or the intranet based on standards and specifications. The input/output interface 95 and the communication interface 96 may be commonly used as an interface that connects to an external device.

The information processing apparatus 90 may be configured to be connected to an input device such as a keyboard, a mouse, a touch panel, or the like as necessary. These input devices are used to input information and settings. In a case where the touch panel is used as the input device, it is sufficient to use a configuration in which a display screen of a display device also serves as the interface of the input device. It is sufficient that data communication between the processor 91 and the input device be relayed by the input/output interface 95.

The information processing apparatus 90 may include a display device used to display information. In a case where the display device is included, it is preferable that the information processing apparatus 90 include a display control device (not illustrated) that controls the display of the display device. It is sufficient that the display device be connected to the information processing apparatus 90 via the input/output interface 95.

The information processing apparatus 90 may include a disk drive as necessary. The disk drive is connected to the bus 99. Between the processor 91 and a recording medium (program recording medium) which is not illustrated, the disk drive relays reading of a data program from the recording medium, writing a processing result of the information processing apparatus 90 to the recording medium, or the like. The recording medium can be achieved, for example, by an optical recording medium such as a Compact Disc (CD) or a Digital Versatile Disc (DVD). The recording medium may be achieved by a semiconductor recording medium such as a Universal Serial Bus (USB) memory or a Secure Digital (SD) card, a magnetic recording medium such as a flexible disk, or other recording medium.

The above is an example of the hardware configuration that enables the terminal device and the server device according to each example embodiment of the present invention. The hardware configuration in FIG. 18 is an example of the hardware configuration that executes the processing by the terminal device and the server device according to each example embodiment and does not limit the scope of the present invention. A program that causes a computer to execute processing regarding the terminal device and the server device according to each example embodiment is included in the scope of the present invention. Moreover, a program recording medium that has recorded the program according to each example embodiment is included in the scope of the present invention.

Components of the terminal device and the server device according to each example embodiment can be optionally combined. The components of the terminal device and the server device according to each example embodiment may be achieved by software or a circuit.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-093665, filed on May 15, 2018, the disclosure of which is incorporated herein in its entirety by reference.

### REFERENCE SIGNS LIST

10, 20, 30 positioning system
11, 21, 31 terminal device
12, 22, 32 server device
33 beacon
111, 211, 311 first signal reception unit
112, 212, 312 first positioning unit
113, 213, 313 second positioning unit
114, 214, 314 inquiry unit
116, 216, 316 positioning method switching unit
118, 218, 318 positioning result output unit
215 wireless communication unit
315 second signal reception unit

What is claimed is:

1. A positioning system comprising:
a server device configured to transmit a positioning method setting instruction for specifying a positioning method based on a position of a terminal device to the terminal device; and
a terminal device configured to measure a position of the terminal device by using at least either one of a first positioning method using first positioning signals transmitted from a plurality of satellites included in a global positioning system or at least one second positioning method different from the first positioning method according to the positioning method setting instruction.

2. The positioning system according to claim 1, wherein
the server device
includes a database that stores a positioning method linked to a position in a positioning target region, selects a positioning method related to the position of the terminal device from the database, and transmits, to the terminal device, the positioning method setting instruction for specifying the selected positioning method to the terminal device.

3. The positioning system according to claim 2, wherein
the terminal device
transmits a primary positioning result including the position of the terminal device to the server device, and
the server device
receives the primary positioning result, selects a positioning method related to the position of the terminal device included in the received primary positioning result from the database, and transmits the positioning method setting instruction for specifying the selected positioning method to the terminal device.

4. The positioning system according to claim 2, wherein
the server device
acquires the position of the terminal device via a network, selects a positioning method related to the acquired position of the terminal device from the database, and transmits the positioning method setting instruction for specifying the selected positioning method to the terminal device.

5. The positioning system according to claim 2, wherein
the server device
transmits coordinates that define a positioning region linked to a positioning method, to the terminal device, as including the coordinates in the positioning method setting instruction, and
the terminal device
sets a positioning method based on a specific positioning region defined by the coordinates included in the positioning method setting instruction and the position of the terminal device.

6. The positioning system according to claim 3, wherein
the server device includes
at least one memory storing instructions; and
at least one processor connected to the at least one memory and configured to execute the instructions to
receive the primary positioning result from the terminal device,
select, by referring to the database, a positioning method of the terminal device related to the position of the terminal device included in the received primary positioning result, and
transmit the positioning method setting instruction for specifying the selected positioning method to the terminal device.

7. The positioning system according to claim 1, wherein
the terminal device includes
wireless communicator that is wirelessly connectable to a network connected to the server device.

8. The positioning system according to claim 1, further comprising:
a beacon that transmits the positioning method setting instruction for specifying a positioning method in a specific region, wherein
the terminal device
receives the positioning method setting instruction from the beacon and outputs a positioning result by a positioning method according to the positioning method setting instruction.

9. A terminal device comprising:
at least one memory storing instructions; and
at least one processor connected to the at least one memory and configured to execute the instructions to:
receive first positioning signals transmitted from a plurality of satellites included in a global positioning system;
measure a position of the terminal device by a first positioning method using the first positioning signal;
measure the position of the terminal device by at least one second positioning method different from the first positioning method;
transmit a primary positioning result including the position of the terminal device to a server device;
receive a positioning method setting instruction according to the primary positioning result from the server device;
select a positioning result measured by a positioning method based on the received positioning method setting instruction; and
output the selected positioning result.

10. A positioning method comprising:
transmitting a positioning method setting instruction for specifying a positioning method based on a position of a terminal device to the terminal device; and
measuring the position of the terminal device by using at least either one of a first positioning method using first positioning signals transmitted from a plurality of satellites included in a global positioning system or at least one second positioning method different from the first positioning method according to the positioning method setting instruction.
